(19) United States
(12) Patent Application Publication
(10) Pub. No.: US 2021/0299861 A1
(43) Pub. Date: Sep. 30, 2021

(54) CONTROL SYSTEM AND CONTROL METHOD

(71) Applicant: MITSUBISHI HEAVY INDUSTRIES, LTD., Tokyo (JP)

(72) Inventors: Junpei YAMAGUCHI, Tokyo (JP); Masanobu TSUTSUI, Tokyo (JP)

(21) Appl. No.: 17/263,027

(22) PCT Filed: Apr. 25, 2019
(86) PCT No.: PCT/JP2019/017628

§ 371 Date: Jan. 25, 2021

(30) Foreign Application Priority Data
Sep. 28, 2018 (JP) 2018-184562

(51) Int. Cl. B25J 9/16; B25J 13/08

(52) U.S. Cl. CPC B25J 9/163; B25J 13/088; B25J 9/1664; B25J 9/1682

(57) ABSTRACT

The invention decreases time required for a robot teaching operation, and reduces burden on an operator. A teaching operation assistance system includes teaching data including a target position/attitude of an end effector disposed at the tip of a mounting robot and robot control information corresponding to each target position/attitude; a laser tracker measuring the position/attitude of the end effector when the mounting robot has been operated in accordance with the teaching data; and a corrected teaching data creation unit for creating corrected teaching data, which is obtained by correcting the teaching data to bring the position/attitude measured by the laser tracker closer to the target position/attitude of the end effector in the teaching data. The laser tracker defines a coordinate system by detecting the positions of three coordinate system-defining reflectors disposed on a flat plate portion, and measures the position/attitude of the end effector in the coordinate system.

### TECHNICAL FIELD

The present invention relates to a robot teaching operation assistance system and a robot teaching operation assistance method.

### BACKGROUND ART

A teaching operation (teaching) which teaches an industrial robot the content of the actions and operations to be performed in advance is required in order to direct the robot to perform operations. Then, in a case in which the industrial robot is directed to perform an operation requiring relatively accurate positioning, for example, an assembly operation, such as the mounting, insertion, and processing of components, it is necessary to perform the actual matching teaching operation for eliminating model errors, the deviation of the coordinates of the robot, the positional errors of counterpart components, and the like.

### CITATION LIST

### Patent Literature

[PTL 1] Japanese Unexamined Patent Application Publication No. 2015-42436

### SUMMARY OF INVENTION

### Technical Problem

In the related art, the above-mentioned actual matching teaching operation needs to be performed by an operator having specialized knowledge for a long period of time, which is an obstacle to efficiency improvement.

The invention has been made in view of the above-mentioned problems, and an object of the invention is to provide a robot teaching operation assistance system and a robot teaching operation assistance method that can shorten the time required for a robot teaching operation and reduce a burden on an operator.

### Solution to Problem

According to a first aspect of the invention, there is provided a robot teaching operation assistance system including: teaching data including a target position and attitude of an end effector that is provided at a leading end of a robot and control information of the robot corresponding to each target position and attitude; a measurement device that measures a position and attitude of the end effector in a case in which the robot has been operated according to the teaching data; and a corrected teaching data creation unit that creates corrected teaching data obtained by correcting the teaching data such that the position and attitude measured by the measurement device is close to the target position and attitude of the end effector in the teaching data. The measurement device detects a position of a coordinate system-defining target disposed in a space, in which the robot is installed, to define a coordinate system and measures the position and attitude of the end effector in the coordinate system.

According to the above-mentioned configuration, the position and attitude of the end effector in a case in which the robot has been operated according to the teaching data is measured, and the corrected teaching data obtained by correcting the teaching data such that the measured position and attitude is close to the target position and attitude in the teaching data is created. Therefore, it is possible to automatically perform the actual matching teaching operation. Therefore, it is possible to shorten the time required for the robot teaching operation and to reduce the burden on the operator.

The measurement device detects the position of the coordinate system-defining target disposed in the space, in which the robot is installed, to define the coordinate system of the robot, and measures the position and attitude of the end effector in the defined coordinate system. Therefore, for example, even in a case in which the coordinate system of the robot and the measurement device are moved relatively, it is possible to specify the coordinate system of the robot whenever the relative movement is performed and to measure the position and attitude of the end effector in the coordinate system.

In the robot teaching operation assistance system, the corrected teaching data creation unit may create the corrected teaching data by repeatedly adjusting the control information of the robot in the teaching data until a difference between the target position and attitude of the end effector in the teaching data and the position and attitude of the end effector measured by the measurement device is within a predetermined allowable range.

According to the above-mentioned configuration, the corrected teaching data is created in which the difference between the position and attitude of the end effector measured by the measurement device and the target position and attitude of the end effector in the teaching data is within the predetermined allowable range. Therefore, the use of the corrected teaching data for control makes it possible to suppress a control error of the robot within an allowable range.

In the robot teaching operation assistance system, the robot may be a robot that performs a predetermined operation for a plurality of operation points set at intervals in a longitudinal direction of a long workpiece. The teaching data may include a target position and attitude of the end effector corresponding to each operation point and control information of the robot corresponding to each position and attitude of the end effector. The measurement device may measure the position and attitude of the end effector in a case in which the robot has been operated according to the teaching data for each operation point. The corrected teaching data creation unit may create the corrected teaching data in which the control information of the robot has been corrected for each operation point.

According to the above-mentioned configuration, it is possible to obtain the corrected teaching data obtained by correcting the teaching data for a plurality of operation points set at intervals in the longitudinal direction of the long workpiece. Therefore, even in a case in which an operation is performed for a plurality of operation points, it is possible to suppress a control error at each operation point within an allowable range.

According to a second aspect of the invention, there is provided a control system including the robot teaching operation assistance system. The control system controls the robot on the basis of the corrected teaching data when the robot is operated.

According to a third aspect of the invention, there is provided a control system that is applied to an assembly apparatus including a plurality of first robots that grip a long workpiece, a transport device that moves the first robots along a longitudinal direction of the workpiece, and a second robot that performs a predetermined operation for a plurality of operation points set at intervals in the longitudinal direction of the workpiece. The control system includes: teaching data including a target position and attitude of an end effector of the second robot corresponding to each operation point and control information of the second robot corresponding to each target position and attitude of the end effector; a measurement device that measures a position and attitude of the end effector in a case in which the second robot has been operated according to the teaching data for each operation point; and a corrected teaching data creation unit that creates corrected teaching data obtained by correcting the teaching data such that the position and attitude measured by the measurement device is close to the target position and attitude of the end effector in the teaching data for each operation point. The measurement device detects a position of a coordinate system-defining target, which is moved together with the transport device, to define a coordinate system and measures the position and attitude of the end effector in the coordinate system.

According to a fourth aspect of the invention, there is provided a robot teaching operation assistance method including: a step of measuring a position and attitude of an end effector provided at a leading end of a robot in a case in which the robot has been operated according to teaching data including a target position and attitude of the end effector and control information of the robot corresponding to each target position and attitude; and a step of creating corrected teaching data obtained by correcting the teaching data such that the measured position and attitude of the end effector is close to the target position and attitude of the end effector in the teaching data. In the step of measuring the position and attitude of the end effector, a position of a coordinate system-defining target disposed in a space, in which the robot is installed, is detected to define a coordinate system, and the position and attitude of the end effector in the coordinate system is measured.

### Advantageous Effects of Invention

It is possible to obtain the effect of shortening the time required for a robot teaching operation and reducing a burden on the operator.

### BRIEF DESCRIPTION OF DRAWINGS

FIG. 1 is a plan view illustrating an assembly apparatus according to an embodiment of the invention.

FIG. 2 is a schematic configuration diagram schematically illustrating a mounting robot according to the embodiment of the invention.

FIG. 3 is a diagram illustrating a schematic configuration of a control system that controls the assembly apparatus according to the embodiment of the invention.

FIG. 4 is a diagram illustrating a schematic configuration of a general 6-axis-driven robot.

FIG. 5 is a functional block diagram illustrating an example of the functions of a teaching operation assistance device according to the embodiment of the invention.

FIG. 6 is a diagram illustrating an example of teaching data according to the embodiment of the invention.

FIG. 7 is a diagram illustrating an example of corrected teaching data according to the embodiment of the invention.

FIG. 8 is a flowchart illustrating an example of the procedure of a robot teaching operation assistance method according to the embodiment of the invention.

### DESCRIPTION OF EMBODIMENTS

Hereinafter, a robot teaching operation assistance system and a robot teaching operation assistance method according to an embodiment of the invention will be described. In this embodiment, a case in which the robot teaching operation assistance system is applied to an assembly apparatus is described as an example. However, the application of the invention is not limited to this example, and the invention can be widely applied to various robot teaching operations.

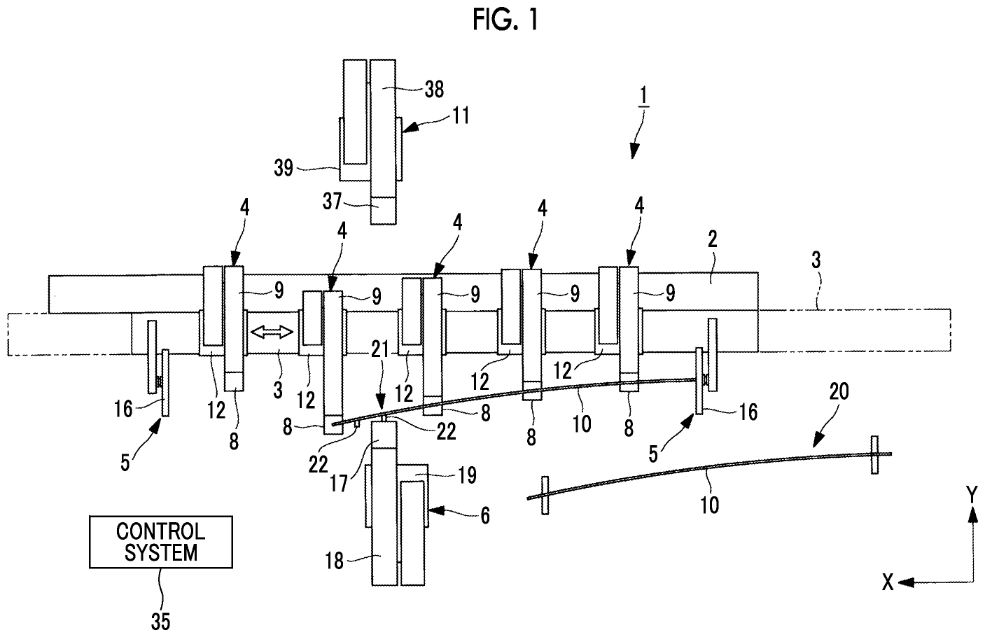

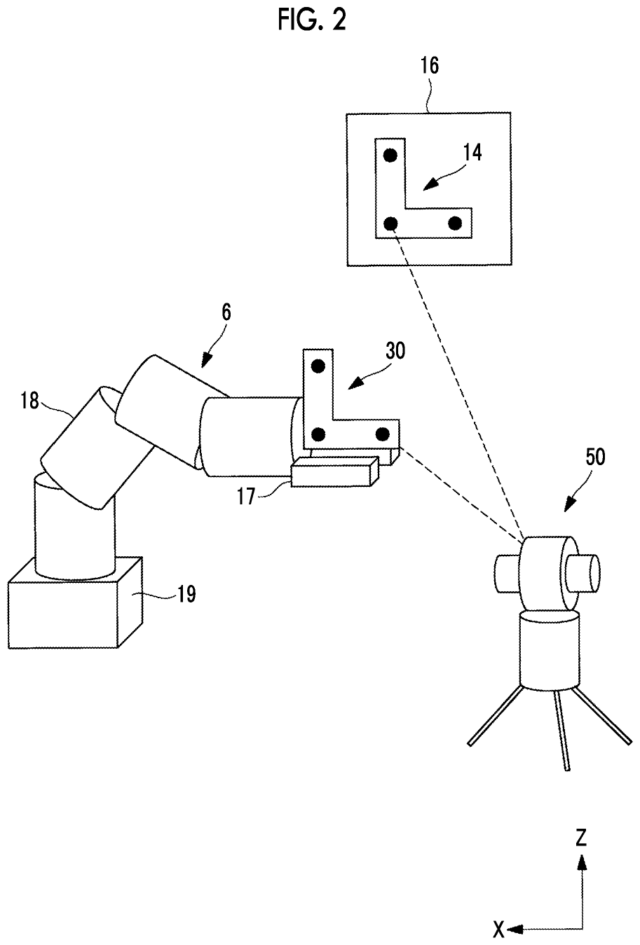

FIG. 1 is a plan view schematically illustrating an assembly apparatus 1 according to the embodiment of the invention. As illustrated in FIG. 1, the assembly apparatus 1 includes, for example, a transport device 2, a table 3, a plurality of support robots (first robots) 4, an abutting plate 5, a mounting robot (second robot) 6, a laser tracker (measurement device) 50 (see FIG. 2), and a gripping robot 11.

The assembly apparatus 1 takes out a stringer 10 which is a long member from a supply position 20 and transports the stringer 10 to a mounting position 21. Then, a clip 22 is mounted on the stringer 10 at the mounting position 21. The stringer 10 before the clip 22 is mounted is temporarily placed at the supply position 20, and the mounting robot 6 and the gripping robot 11 are fixedly placed on the floor in the vicinity of the mounting position 21.

The stringer 10 is, for example, a structural member of an aircraft, has a length of about 5 m to 15 m, and has, for example, a compound-curved shape and a three-dimensional shape. The clip 22 is a component for connecting a long frame connected to a plurality of stringers 10. The clip 22 is mounted at an accurate position in a longitudinal direction of the stringer 10, which makes it possible to connect a frame across a plurality of stringers 10 without bending when it is assembled to the plurality of stringers 10.

A commonly used device can be applied as the transport device 2, and the table 3 which will be described below is placed on the transport device 2. The transport device 2 moves the table 3 from one end to the other end and from the other end to one end. The one end of the transport device 2 is in the vicinity of the supply position 20 of the stringer 10, and the transport device 2 moves the table 3 from the vicinity of the supply position 20 to the vicinity of the mounting robot 6.

In a case in which the mounting robot 6 mounts the clips 22 at a plurality of operation points set at intervals along the longitudinal direction of the stringer 10, the transport device 2 is moved by a predetermined amount after the mounting of the clip 22 at a certain operation point of the stringer 10 is completed. Therefore, the stringer 10 is transported by a predetermined amount while being held by the support robot 4 in a state in which the component shape of the stringer 10 is maintained as a predetermined holding shape, and it is possible to move the next operation point to the position of the mounting robot 6. Then, when the mounting of the clip 22 at this operation point is completed, the transport device 2 is moved by a predetermined amount to move the next operation point to the position of the mounting robot 6. Then, this operation is repeated to mount the clips 22 on the entire stringer 10 in the longitudinal direction.

A plurality of support robots 4 and the abutting plates 5 are installed in a row on the table 3. Therefore, the plurality of support robots 4 and the abutting plates 5 are moved integrally on the transport device 2. The plurality of support robots 4 are placed in a row on the table 3, and the abutting plates 5 are placed at both ends of the table 3, that is, on both sides of the plurality of support robots 4. The number of support robots 4 placed on the table 3 or the distance between the support robots 4 is preset according to the stringer 10 as an assembly target. The number of support robots 4 that operate to grip the stringer 10 is determined according to the length of the stringer 10 that is actually gripped. FIG. 1 illustrates an aspect in which four of the five support robots 4 grip the stringer 10.

The abutting plate 5 has, for example, a flat plate portion 16, and one end of the stringer 10 is abutted on a surface of the flat plate portion 16. The abutting plate 5 has a configuration for restraining one end of the stringer 10. Therefore, one end of the stringer 10 that is abutted on the abutting plate 5 can be used as a reference position for positioning when another clip 22 is mounted.

The abutting plate 5 is an example of a positioning member for defining the reference position, and the configuration is not limited to this example. That is, the positioning member may have a function for defining the reference position and may be, for example, a member on a flat plate on which a pin-shaped protrusion is provided in a positioning portion. In this case, one end of the stringer is positioned by inserting the pin-shaped protrusion into a hole that is provided in advance in the stringer or a component fixed to the stringer.

As illustrated in FIG. 2, the flat plate portion 16 of the abutting plate 5 is provided with at least three reflectors 14 that form a coordinate system-defining target for defining the coordinate system of the assembly apparatus 1.

The laser tracker 50 measures the position of each of the reflectors 14 by irradiating the three reflectors 14 forming the coordinate system-defining target with laser light and receiving light reflected from the reflectors 14. Then, a workpiece coordinate system which is the reference coordinate system of the assembly apparatus 1 is specified from the positional information of the three reflectors 14. Then, the positions and attitudes of end effectors 8, 17, and 37 included in the support robot 4, the mounting robot 6, and the gripping robot 11, which will be described later, are detected on the basis of the workpiece coordinate system. The detection of the attitude of the end effector is not limited to the three reflectors. For example, a 6DoF tracking device may be used. The 6DoF tracking device is, for example, a device that has a laser tracker and a camera, irradiates a reflector provided in a central portion of the coordinate system-defining target with laser light, receives light reflected from the reflector to measure the position of the reflector, captures the image of one or a plurality of LEDs mounted on the surface of the target with the camera, and processes the image to detect the attitude.

The abutting plates 5 are placed at both ends of the table 3, that is, on both sides of the plurality of support robots 4. When the stringer 10 is brought into contact with the abutting plate 5, only one of the two abutting plates 5 is used. The abutting plate 5 is selected according to the reference position (direction) of the stringer 10.

The support robot 4 includes, for example, the end effector 8 having a configuration for gripping the stringer 10, an arm portion 9 having the end effector 8 provided at the leading end thereof, and a body portion 12 for supporting the arm portion 9.

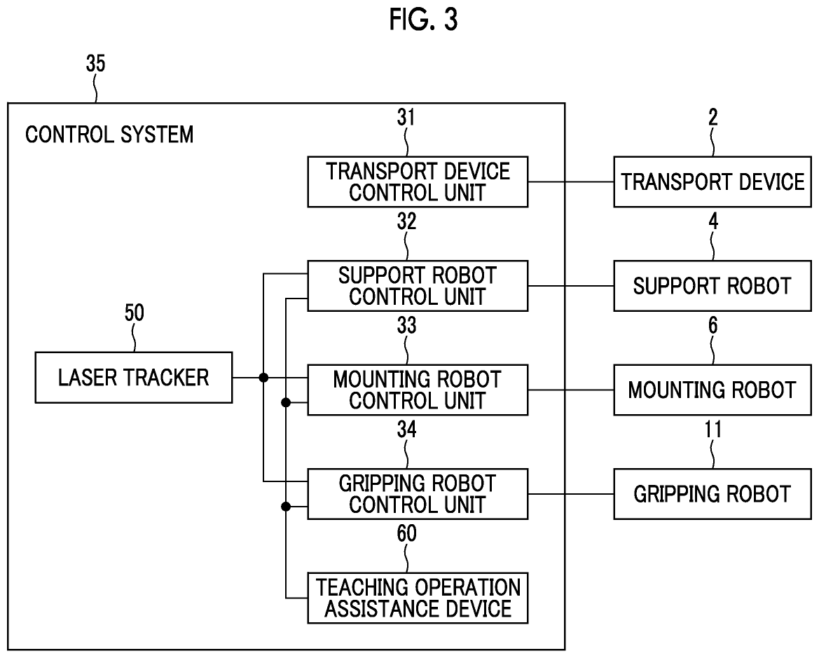

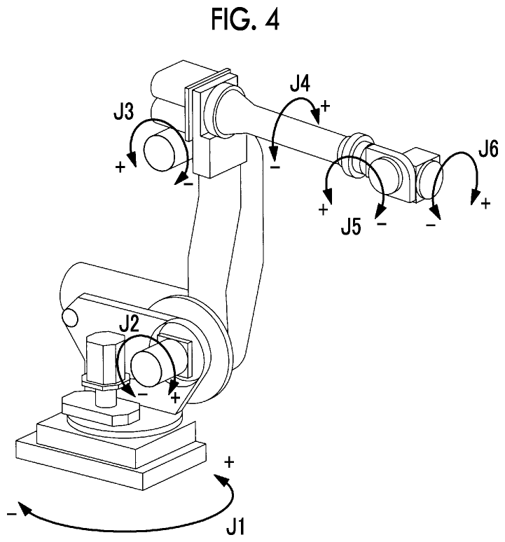

The end effector 8 is provided with measurement points (not illustrated) for measuring the position and attitude of the end effector 8. For example, at least three reflectors are provided at the measurement points, and the positions of the reflectors are detected by the laser tracker 50 (see FIG. 4). The detection of the positions of the three reflectors makes it possible to detect not only the position of the end effector 8 but also the attitude of the end effector 8. The positional information of the three reflectors measured by the laser tracker 50 is output to a support robot control unit 32 (see FIG. 3), which will be described below, and is used for controlling the support robot 4.

The arm portion 9 and the body portion 12 have a configuration that moves the end effector 8 such that the end effector 8 can appropriately support the stringer 10. A commonly used robot configuration can be applied to the arm portion 9 and the body portion 12.

As illustrated in FIGS. 1 and 2, the mounting robot 6 includes, for example, the end effector 17 that mounts the clips 22 to a plurality of operation points set at intervals in the longitudinal direction of the stringer 10, an arm portion 18 that has the end effector 17 provided at the leading end thereof, and a body portion 19 that supports the arm portion 18. One mounting robot 6 may be provided as illustrated in FIG. 1, or a plurality of mounting robots 6 may be provided.

As illustrated in FIG. 2, the end effector 17 is provided with measurement points for measuring the position and attitude of the end effector 17. For example, at least three reflectors 30 are provided at the measurement points. The positions of the reflectors 30 are detected by the laser tracker 50 to detect the position and attitude of the end effector 17. The positional information of the reflector (in other words, the position and attitude of the end effector 17) measured by the laser tracker 50 is output to the mounting robot control unit 33 (see FIG. 3), which will be described below, and is used for controlling the mounting robot 6.

The arm portion 18 and the body portion 19 have a configuration that moves the clip 22 gripped by the end effector 17 to the operation point of the stringer 10. A commonly used robot configuration can be applied to the arm portion 9 and the body portion 12. In addition, the mounting robot 6 may have a function of clamping, drilling, or riveting the clip 22.

The gripping robot 11 includes, for example, the end effector 37 for gripping the stringer 10 and the clip 22, an arm portion 38 having the end effector 37 provided at the leading end thereof, and a body portion 39 for supporting the arm portion 38.

The end effector 37 is provided with measurement points (not illustrated) for measuring the position and attitude of the end effector 37. For example, at least three reflectors are provided at the measurement points. The positions of the reflectors are detected by the laser tracker 50 to detect the position and attitude of the end effector 37. The positional information of the reflectors measured by the laser tracker 50, that is, information of the position and attitude of the end effector 37 is output to a gripping robot control unit 34 (see FIG. 3), which will be described below, and is used for controlling the gripping robot 11.

The arm portion 38 and the body portion 39 have a configuration that moves the end effector 37 such that the end effector 37 can appropriately support the stringer 10. A commonly used robot configuration can be applied to the arm portion 38 and the body portion 39.

The laser tracker 50 performs scanning with laser light and detects the position of each reflector using the reflected light of the laser light reflected from the reflectors provided at each measurement point. The laser tracker 50 is fixedly installed at a position different from the positions of the transport device 2, the support robot 4, the mounting robot 6, and the gripping robot 11. Therefore, the reference coordinate system (workpiece coordinate system) of the assembly apparatus 1 is moved relative to the laser tracker 50.

As illustrated in FIG. 3, a control system 35 that controls the assembly apparatus 1 includes, for example, a transport device control unit 31, the support robot control unit 32, the mounting robot control unit 33, the gripping robot control unit 34, the laser tracker 50, and a teaching operation assistance device 60.

The control system 35 includes, for example, a central processing unit (CPU), a random access memory (RAM), a read only memory (ROM), and a computer-readable storage medium. Then, a series of processes for implementing various functions is stored in a storage medium or the like in the form of a program as an example. The CPU reads this program to the RAM or the like and performs information processing and arithmetic processing to implement the functions of the control units 31 to 34 and the teaching operation assistance device which will be described below. The following forms may be applied to the program: a form in which the program is installed in the ROM or other storage media in advance; a form in which the program is provided in a state of being stored in the computer-readable storage medium; and a form in which the program is distributed through a wired or wireless communication means. Examples of the computer-readable storage medium include a magnetic disk, a magneto-optical disk, a CD-ROM, a DVD-ROM, and a semiconductor memory.

The transport device control unit 31 adjusts the position of the transport device 2 such that a predetermined region of the stringer 10 is moved to the mounting position 21. The transport device control unit 31 controls the movement of the transport device 2 such that a plurality of operation points provided at intervals in the longitudinal direction of the stringer 10 sequentially come to the mounting position of the mounting robot 6. For example, the transport device control unit 31 may be included in the support robot control unit 32 which will be described below. That is, the support robot control unit 32, which will be described below, may control the movement of the transport device 2.

The support robot control unit 32 moves the end effector 8 to a predetermined target position or brings an end portion of the stringer 10 into contact with the abutting plate 5, on the basis of the position of the reflector measured by the laser tracker 50, that is, the position and attitude of the end effector 8.

The mounting robot control unit 33 controls the mounting robot 6 on the basis of the position of the reflector 30 measured by the laser tracker 50 such that the end effector 17 is operated to mount the clip 22 on the operation point moved to the mounting position 21.

The gripping robot control unit 34 moves the end effector 37 to a predetermined target position on the basis of the position and attitude of the end effector 37 measured by the laser tracker 50 to assist the gripping of the stringer 10 by the support robot 4.

The laser tracker 50 may detect the positions and attitudes of various robots including the support robot 4 in response to commands received from the transport device control unit 31, the support robot control unit 32, the mounting robot control unit 33, and the gripping robot control unit 34 and transmit the detected positions and attitudes to each of the control units 31 to 34. That is, the laser tracker 50 may also be controlled by each of the control units 31 to 34. In the control system 35, the support robot control unit 32, the mounting robot control unit 33, and the gripping robot control unit 34 have control programs for controlling the support robot 4, the mounting robot 6, and the gripping robot 11, respectively. The control programs include information related to the target positions of the end effectors of various robots and teaching data in which control data for moving the end effectors to the target positions has been registered.

For example, FIG. 4 illustrates the schematic configuration of a general 6-axis-driven robot. As such, the robot can control the angle of each joint to guide the end effector (not illustrated) provided at the leading end of the robot to a desired position. For example, angular information items J1 to J6 of six joints corresponding to the target position of the end effector are registered in the control data forming the teaching data.

Here, since the above-mentioned teaching data is data created on the computer, it is necessary to perform an actual matching teaching operation for matching with the actual machine. The teaching operation assistance system according to this embodiment has a function of correcting the teaching data created on the computer so as to be matched with the actual machine in a stage before the assembly apparatus 1 starts assembling.

Hereinafter, for the teaching operation assistance system according to this embodiment, a case in which the teaching data of the mounting robot control unit 33 is corrected will be described as an example. In this embodiment, as illustrated in FIG. 3, the teaching operation assistance device 60 is incorporated into the control system 35. However, the invention is not limited to this example, and the teaching operation assistance device 60 may be provided independent of the control system 35.

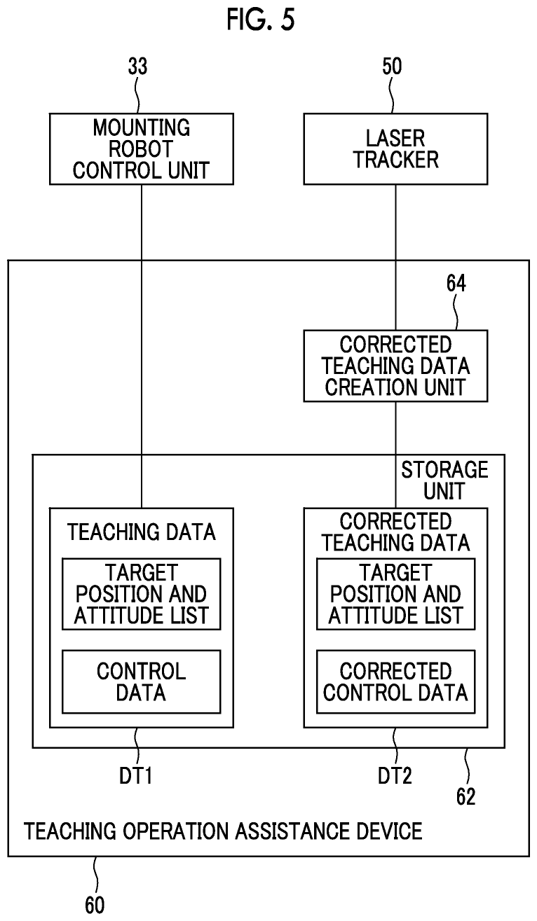

FIG. 5 is a functional block diagram extracting and illustrating the functions of a teaching data assistance device for correcting the teaching data of the mounting robot control unit 33. As illustrated in FIG. 5, the teaching operation assistance device 60 includes a storage unit 62 and a corrected teaching data creation unit 64.

The robot teaching operation assistance system according to this embodiment includes the teaching operation assistance device 60 and the laser tracker 50.

The storage unit 62 of the teaching operation assistance device 60 stores teaching data DT1 for the mounting robot 6 created in advance by the computer and corrected teaching data DT2 created by a process of the corrected teaching data creation unit 64 which will be described below.

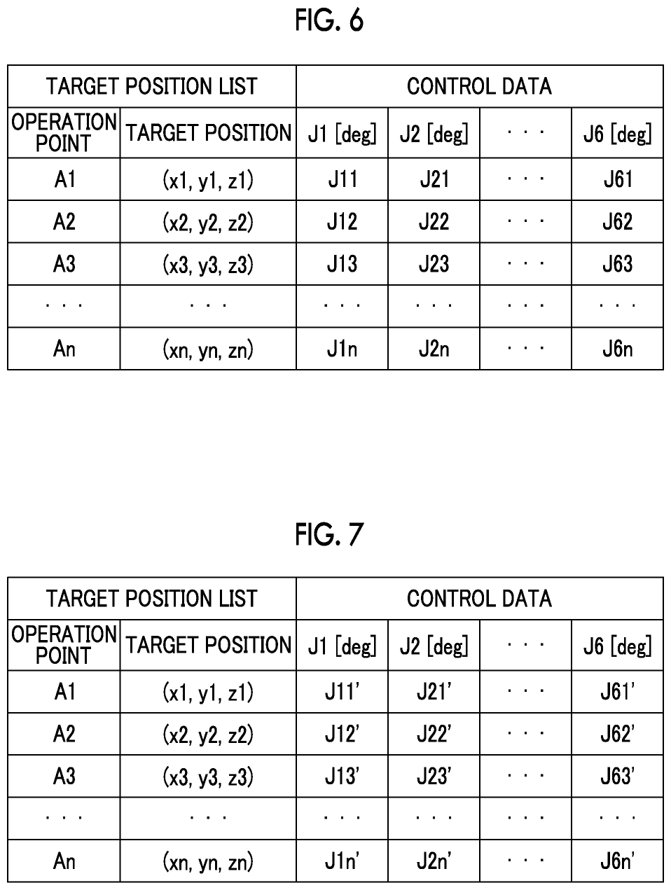

For example, FIG. 6 illustrates an example of the teaching data DT1. As illustrated in FIG. 6, the following are registered in the teaching data DT1: a target position list in which the target positions of the end effector 17 of the mounting robot 6 at each of a plurality of operation points A1 to An set at intervals along the longitudinal direction of the stringer 10 are registered; and control data for moving the end effector 17 to each target position described in the target position list, for example, the angular information items J1 to J6 of each joint.

The corrected teaching data creation unit 64 creates corrected teaching data obtained by correcting the control data items J1 to J6 of the teaching data DT1, on the basis of the position and attitude of the end effector 17 when the mounting robot control unit 33 controls the mounting robot 6 on the basis of the teaching data DT1, and stores the created corrected teaching data in the storage unit 62. FIG. 7 illustrates an example of the corrected teaching data DT2. As illustrated in FIG. 7, the control data corrected for the target position is registered.

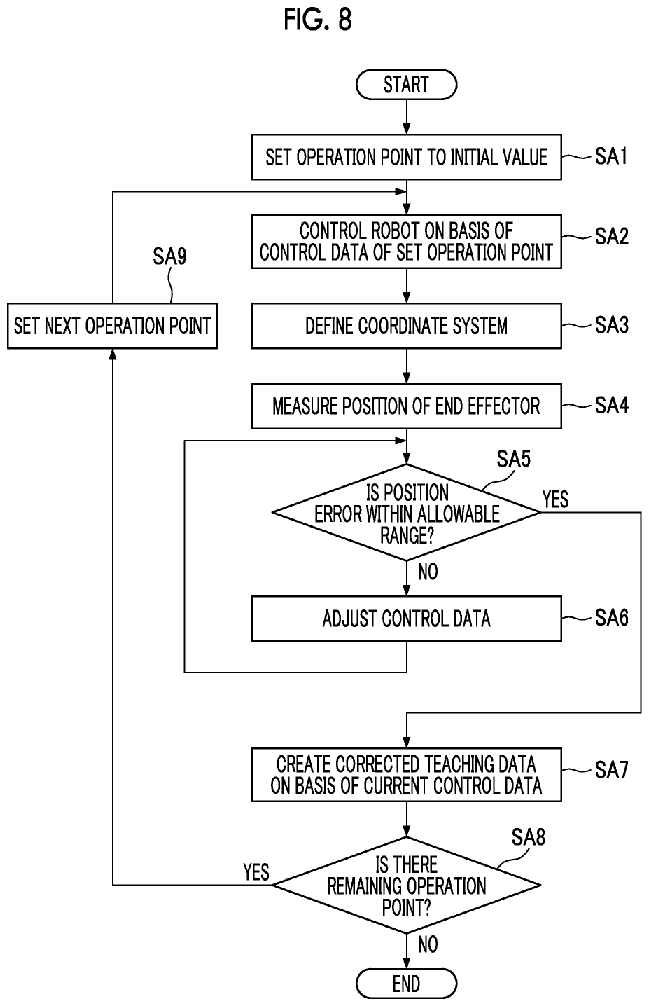

Next, a robot teaching operation assistance method performed by the robot teaching operation assistance system according to the embodiment of the invention will be described with reference to FIG. 8. FIG. 8 is a flowchart illustrating an example of the procedure of the robot teaching operation assistance method according to this embodiment.

First, in the teaching data DT1, the operation point is set as the operation point A1 which is an initial value (SA1). Then, the robot is controlled on the basis of the control data of the set operation point A1 (SA2). Therefore, the mounting robot control unit 33 drives each joint of the mounting robot 6 on the basis of the control data items J11 to J61 corresponding to the operation point A1 to move the position of the end effector 17. With this control, the transport device 2 of the assembly apparatus 1 is controlled such that the operation point (the mounting position of the clip 22) A1 set on the stringer 10 comes to the mounting position 21 of the end effector 17. In this case, the control is performed in a state in which the stringer 10 or the clip 22 is not gripped since it is only for positioning.

Then, the laser tracker 50 measures the reflector 14 (see FIG. 2) provided on the flat plate portion 16 to define the workpiece coordinate system (SA3). Then, the position of the reflector 30 provided on the end effector 17 of the mounting robot 6 is measured on the basis of the workpiece coordinate system (SA4).

Then, an error between the target position registered in the teaching data DT1 and the measured position of the end effector 17 measured by the laser tracker 50 is calculated, and it is determined whether or not the calculated position error is within a preset allowable range (SA5). When the determination result shows that the error is not within the allowable range (SA5: NO), the control data is repeatedly adjusted such that the error is within the allowable range (SA6).

Then, when the error is within the allowable range (SA5: YES), the corrected teaching data DT2 is created on the basis of the current control data items J11′ to J61′ (SA7). Then, the adjusted control data items J11′ to J61′ for the target position of the end effector 17 are registered as the control data of the corrected teaching data. In a case in which the mounting robot 6 is controlled on the basis of the control data items J11 to J61 of the teaching data DT1, when the position of the end effector 17 has already been within the allowable range of the target position, it is not necessary to correct the control data. Therefore, the same control data items J11 to J61 as those of the teaching data DT1 are registered as the control data items J11 to J61 of the corrected teaching data.

Then, it is determined whether or not there are remaining operation points (SA8). In a case in which there are remaining operation points (SA8: YES), the next operation point, that is, the operation point A2 is set (SA9). The process after step SA2 is also repeated for the operation point A2. In this case, the position of the laser tracker 50 fixed to the floor and the position of the support robot 4 and the flat plate portion 16 mounted on the transport device 2 change relatively depending on the operation point. Therefore, as illustrated in Step SA3 of FIG. 8, whenever the transport device 2 is moved, the position of the reflector 14 provided on the flat plate portion 16 is detected by the laser tracker 50 and the workpiece coordinate system is defined.

Then, when Steps SA2 to SA8 are repeated to create the corrected teaching data DT2 for all of the operation points A1 to An registered in the teaching data DT1 (SA8: NO), this process ends.

In the above description, the teaching operation assistance method for the teaching data related to the mounting robot 6 has been described as an example. However, for teaching data for the support robot 4 or the gripping robot 11, the corrected teaching data can be easily obtained by the same method as described above.

As described above, according to the robot teaching operation assistance system and the robot teaching operation assistance method according to this embodiment, the position and attitude of the end effector 17 in a case in which the mounting robot 6 has been operated according to the teaching data DT1 is measured by the laser tracker 50, and the corrected teaching data DT2 obtained by correcting the teaching data DT1 such that the measured position and attitude of the end effector 17 is close to the target position and attitude of the teaching data DT1 is created. Therefore, it is possible to automatically perform the actual matching teaching operation. Therefore, it is possible to shorten the time required for the robot teaching operation and to reduce the burden on the operator.

The laser tracker 50 detects the position of the reflector 14, which is a coordinate system-defining target disposed in the space in which the mounting robot 6 is installed, to define the coordinate system (workpiece coordinate system) of the assembly apparatus 1 and measures the position and attitude of the end effector 17 in the defined coordinate system. Therefore, for example, even in a case in which the coordinate system of the assembly apparatus 1 and the laser tracker 50 are moved relatively, it is possible to specify the coordinate system of the assembly apparatus 1 whenever the relative movement is performed and to measure the position and attitude of the end effector 17 in the coordinate system.

The corrected teaching data creation unit 64 repeatedly adjusts the control data of the mounting robot 6 until the difference between the target position and attitude of the end effector 17 in the teaching data DT1 and the position and attitude of the end effector 17 measured by the laser tracker 50 is within a predetermined allowable range to create the corrected teaching data. Therefore, it is possible to suppress the control error of the mounting robot 6 within an allowable range by using the corrected teaching data for controlling the mounting robot at the time of the actual assembly.

According to this embodiment, it is possible to obtain the corrected teaching data DT2 obtained by correcting the teaching data DT1 for the plurality of operation points A1 to An set at intervals in the longitudinal direction of the long stringer. Therefore, even in a case in which an operation is performed for a plurality of operation points, it is possible to suppress a control error at each operation point within an allowable range.

The invention has been described above using the embodiments. However, the technical scope of the invention is not limited to the scope described in the above-described embodiments. Various modifications and improvements can be added to the above-described embodiments without departing from the scope and spirit of the invention, and the aspects to which the modifications and improvements are added are also included in the technical scope of the invention. The above-described embodiments may be appropriately combined with each other.

The flow of the teaching operation assistance method described in the above-described embodiment is also illustrative. Unnecessary steps may be deleted, new steps may be added, or the processing order may be changed without departing from the scope and spirit of the invention.

### REFERENCE SIGNS LIST

1 Assembly apparatus
2 Transport device
4 Support robot
5 Abutting plate
6 Mounting robot
8 End effector
10 Stringer
11 Gripping robot
14 Reflector
16 Flat plate portion
17 End effector
21 Mounting position
22 Clip
30 Reflector
31 Transport device control unit
32 Support robot control unit
33 Mounting robot control unit
34 Gripping robot control unit
35 Control system
50 Laser tracker
60 Teaching operation assistance device
62 Storage unit
64 Corrected teaching data creation unit
DT1 Teaching data
DT2 Corrected teaching data

1.-4. (canceled)

5. A control system that is applied to an assembly apparatus including a plurality of first robots that grip a long workpiece, a transport device that moves the first robots along a longitudinal direction of the workpiece, and a second robot that performs a predetermined operation for a plurality of operation points set at intervals in the longitudinal direction of the workpiece, the control system comprising:
teaching data including a target position and attitude of an end effector of the second robot corresponding to each operation point and control information of the second robot corresponding to each target position and attitude;
a measurement device that measures a position and attitude of the end effector in a case in which the second robot has been operated according to the teaching data for each operation point; and
a corrected teaching data creation unit that creates corrected teaching data obtained by correcting the teaching data such that the position and attitude measured by the measurement device is close to the target position and attitude of the end effector in the teaching data for each operation point,
wherein the measurement device detects a position of a coordinate system-defining target, which is moved together with the transport device, to define a coordinate system and measures the position and attitude of the end effector in the coordinate system.

6. (canceled)

7. The control system according to claim 5,
wherein the corrected teaching data creation unit creates the corrected teaching data by repeatedly adjusting the control information of the second robot in the teaching data until a difference between the target position and attitude of the end effector in the teaching data and the position and attitude of the end effector measured by the measurement device is within a predetermined allowable range.

8. The control system according to claim 5,
wherein the transport device moves the first robots along a longitudinal direction of the workpiece when the first robots do not grip the workpiece or a clipping part.

9. The control system according to claim 5,
wherein the control system controls the second robot on the basis of the corrected teaching data when the second robot is operated.

10. A control method that is applied to an assembly apparatus including a plurality of first robots that grip a long workpiece, a transport device that moves the first robots along a longitudinal direction of the workpiece, and a second robot that performs a predetermined operation for a plurality of operation points set at intervals in the longitudinal direction of the workpiece, the control method comprising:
a step of measuring a position and attitude of the end effector in a case in which the second robot has been operated according to teaching data including a target position and attitude of an end effector of the second robot corresponding to each operation point and control information of the second robot corresponding to each target position and attitude; and
a step of creating corrected teaching data obtained by correcting the teaching data such that the measured position and attitude is close to the target position and attitude of the end effector in the teaching data for each operation point,
wherein, in the step of measuring the position and attitude of the end effector, a position of a coordinate system-defining target is detected each time the transport device moves, to define a coordinate system, and the position and attitude of the end effector in the coordinate system is measured.
